(19) United States
(12) Patent Application Publication
(10) Pub. No.: US 2015/0044337 A1
(43) Pub. Date: Feb. 12, 2015

(54) METHOD FOR PRESERVING FOOD

(71) Applicant: ConAgra Foods RDM, Inc., Omaha, NE (US)

(72) Inventor: Karl Keller, Rafz (CH)

(21) Appl. No.: 14/521,018

(22) Filed: Oct. 22, 2014

Related U.S. Application Data
(63) Continuation of application No. 13/138,490, filed on Aug. 25, 2011, now abandoned.

(30) Foreign Application Priority Data
Feb. 26, 2009 (CH) 00287/09

(51) Int. Cl. A23L 3/01

(52) U.S. Cl. CPC A23L 3/01; A23V 2002/00
USPC 426/234

(57) ABSTRACT

A method for preserving food. The food is heated in a moist state in a container, which has a venting opening and is suited as transport and retail packaging, by way of microwaves (M) for a limited time, however at least until hot steam (D) from in the container and exists through the venting opening. After the heating has ended, a gas (G) is injected into the container using a cannula, and a container wall made of plastic film is pierced with the cannula. The plastic film that is used has a thickness of less than 100 μm. At least one layer of the plastic film is made of polyethylene terephthalate having a thickness of greater than 19 μm.

### CROSS-REFERENCE TO RELATED APPLICATIONS

This application is a continuation of U.S. patent application Ser. No. 13/138,490, filed on Aug. 25, 2011, which is a National Stage application of International Application No. PCT/CH2010/000023, filed on Feb. 1, 2010, which claims priority of Swiss application Serial Number 00287/09, filed on Feb. 26, 2009, all of which are incorporated herein by reference in their entireties.

### FIELD OF INVENTION

The present invention relates to a method for preserving food, in which the food is heated in a moist state in a container, which has a venting opening and is suited as transport and retail packaging, by way of microwaves for a limited time, however at least until hot steam forms in the container and exits through the venting opening. After the heating process, a gas is injected into the container using a cannula, and for this purpose a container wall made of a plastic film is pierced with the cannula. After the gas injection, the venting opening and the pierced hole formed by the cannula in the plastic film are closed.

### BACKGROUND

A method of the aforementioned type is known from WO 2006/084402 A1. In this method the injection of the gas, in particular, serves to avoid the formation of a significant vacuum in the container as a result of condensing steam once said container has been closed.

Reference is made in WO 2006/084402 A1 to EP 1 076 012 A1 with regard to the design of the container. The containers known from EP 1 076 012 A1 have a flat deep-drawn shell made of polypropylene with a peripheral edge. A peripheral weld seam is used to weld a cover film onto this edge, for which 12 μm polyester is covered over approximately 90-100 μm polypropylene. It is this multi-layered plastic film which is pierced by the cannula in order to inject the gas.

It is further known from WO 2006/084402 A 1 to use a gas which is low in oxygen or free from oxygen and to use this to flush the container in order to reduce the content of oxygen in the container which could be particularly harmful to the shelf life of the food.

It is also known from WO 2006/084402 A1 to seal the pierced hole produced with the cannula during the injection process and to simultaneously seal the venting opening by applying an adhesive label.

### SUMMARY

The present invention aims to improve the known method. In particular it has been found that the above-mentioned plastic film is not sufficiently stable, bulges too much when subjected to high temperature and pressure during the heating process, and tends to become rippled as a result of shriveling once the heating process has finished.

In contrast to EP 1 076 012 A1, where the container is opened after the heating process in order to remove the food for consumption and the cover film is no longer important, the plastic film remains on the container for a longer period of time in the method according to the invention and significantly determines the look and appearance of the container during the retail phase.

The behavior of the known cover film is also unfavorable for the piercing by the cannula and the injection process. Ultimately, its rippling impairs the application of the adhesive label.

In accordance with the present invention, as is characterized in claim 1, the plastic film that is used is less than 100 μm thick, at least one layer of the plastic film consisting of polyethylene terephthalate (PET) with a thickness greater than 19 μm.

Although even thinner on the whole than the film known from EP 1 076 012 A1, this film is substantially less ductile under the prevailing temperature and pressure owing to its thicker layer of PET, and returns practically completely back to its original flat form. The aforementioned problems are thus avoided.

In the plastic film used the layer of PET is oriented biaxially, in particular by corresponding stretching. The layer of PET is preferably 23 μm thick. However, it could be up to 40 μm thick.

A multi-layered plastic film in which a second layer consists of polypropylene and the layer of polypropylene is preferably only 2 to 2.5 times thicker than the layer of PET is preferably further used as a plastic film.

In order to improve tightness a barrier layer may also be provided between the two layers, wherein silicon oxide, aluminum oxide and/or ethylene vinyl alcohol is/are used, in particular, for the barrier layer in order to achieve an OTR value of approximately 1.

In accordance with the preferred embodiment of WO 2006/084402 A1, a shell-like container made of plastic is also preferably used as a container within the scope of the present invention, onto which the plastic film is welded in a planar manner as a cover film. The shell-like container may be round, have a diameter of 15-17 cm and a height of 2.5-3.5 cm for a content of approximately 300 g. Oval, rectangular or square shells can also be used.

A multi-layered plastic film in which a second layer consists of a connection layer which enables a connection between the plastic film and the shell can be used as a cover film. For example the above-mentioned layer of polypropylene can be used as a connection layer and can be welded in an effective manner to a shell made of polypropylene.

Before consumption, the food which has been preserved with the aid of the described method is heated in the packaging to consumption temperature, typically in a microwave oven. The use of microwave ovens is not possible or desired in some locations, for example in aircraft. In order to make it possible to heat the food preserved in the packaging in a conventional oven at relatively high temperatures a crystalline polyethylene terephthalate (C-PET) with a higher melting point than amorphous polyethylene terephthalate for example can be used for the shell and the at least one layer of plastic film made of polyethylene terephthalate. An adhesion promoter which enables a connection between the plastic film and the shell can be used as a connection layer. Such a container is therefore more resistant to high temperature and the preserved food contained therein can be heated in a conventional oven at temperatures of approximately 230° C.

With regard to the method, it has been found that it is sufficient to inject the gas at an overpressure of 0.05-0.8 bar, preferably of 0.2-0.4 bar, more preferably of 0.3 bar. A tearing of the plastic film starting from the pierced hole produced by the cannula as a particular weak point is thus simultaneously avoided.

A cannula with a stop collar which is set back slightly compared to the tip of said cannula is used to inject the gas. The cannula is guided in such a way that the stop collar rests at least temporarily against the outer face of the plastic film when the gas is injected.

When driven in a force-controlled manner the cannula can be prevented by the stop collar from penetrating too deeply into the container. The cannula should also not come into contact with the food where possible so it can immediately be used for a further injection of gas in a further container without having to be subjected to an expensive cleaning process. In addition, the risk of any bacteria present in a container being shifted into the subsequent gassed container is thus reduced.

If the plastic film expands again and puffs out due to the injection of the gas at the aforementioned overpressure, it presses against the stop collar, which provides additional protection against tearing of the pierced hole and produces a specific seal around the tip of the cannula. It may be advantageous to withdraw the cannula again slightly after the piercing action so as not to locally block the expansion of the plastic film at the point of piercing.

As is already known from WO 2006/084402 A1, the gas used within the scope of the present invention is also low in oxygen or free from oxygen and the container is flushed with this gas, expelling oxygen through the venting opening. This is preferably carried out until the oxygen content in the container is less than 0.2%, preferably 0.1%.

As is already provided in WO 2006/084402 A1, the venting opening and the pierced hole are then sealed by applying an adhesive label to the plastic film. In order for this to be possible, the two openings cannot of course be distanced too far from one another.

The venting opening and the pierced hole should be closed after the injection process, but not before a waiting time of at least 3 seconds has elapsed. During this waiting time the plastic film puffed out by the gas injection can be relieved again, at least in part, and can again adopt its preferably flat form, which facilitates the application of the adhesive label. In addition, the adhesion of the adhesive label is improved by the cooling of the plastic film, and this cooling is continued further after the waiting time. Having said that, however, the waiting time should not last any longer than 10 seconds.

During the waiting time the content of oxygen previously reduced by the flushing with the gas which is low in oxygen or free from oxygen increases slightly again in the container, at least if said container is arranged in ambient air for example. Although the presence of oxygen is detrimental to the shelf life of the food, an oxygen content of 4-5% is by all means favorable and sometimes even required in order to prevent the formation of botulinum toxin in the container, which requires anaerobic conditions.

In order to ensure a sufficiently long shelf life of the food, the heating should be carried out in such a way that a temperature of 90-98° C. is produced in the core of the food for 30-90 seconds.

The weight loss caused by steam exiting from the container can be determined as a criterion for whether these values have been achieved and can be compared with a predetermined threshold value in order to ascertain whether this has been exceeded.

As already emphasized in WO 2006/084402 A1, it is important for the venting opening to be of a defined size and therefore to have a defined flow resistance which also stays the same when subjected to the stresses during the heating process. In this regard, it has been found that suitable holes, which effectively satisfy these requirements, with a diameter typically of 0.5-10 mm can be formed in the plastic film by hot-needle perforation or flame perforation, but in particular by laser perforation. In this method a fusion bulge is produced around the formed hole as an edge reinforcement. The contactless laser perforation process is carried out, for example, by the use of a high-energy light which is generated by a CO₂ gas laser, wherein the material of the plastic film is plasticized and vaporized, in part, in the lens focus of the laser light.

With geometrically complex packagings, for example a cup packaging with a height of 80 to 140 mm and a small diameter of 60 to 200 mm, the steam generated during heating may possibly be insufficiently displaced by the injected gas owing to the geometry of the packaging. In the case of gas injection into the upper region of a cup packaging steam may remain in the lower third of the packaging, despite the flushing with the injected gas, and the packaging may become dented during the cooling phase.

In order to nevertheless ensure sufficient flushing argon may be used as a flushing gas. The greater density of argon compared to nitrogen leads to improved flushing, even in the lower third of a cup packaging, and thus to reduced denting of the packaging in the cooling phase. However, it has been found that a remaining oxygen content in the container of 4-7% is produced when flushing with argon in contrast to approximately 0.1% when flushing with nitrogen. However, this affords the advantage that the aforementioned formation of botulinum toxin is prevented.

A further option for preventing excessive denting after the heating process in the case of geometrically unfavorable packagings consists in carrying out a second gas injection as well as a cooling step between the first and second gas injection. The first gas injection is carried out as already described. After the first gas injection the venting opening and the pierced hole are sealed by applying an adhesive label. The adhesive label is provided with an adhesive which firmly closes the two openings and no longer opens, even at high pressure and temperature, such that the adhesive does not detach during the second gas injection owing to the slight overpressure and the possible residual heat, and no further gas can escape. The two openings remain firmly closed. The packaging is then cooled in a first cooling step. The packaging constricts slightly during this process. After the first cooling process gas is injected for a second time, the packaging not being flushed this time but merely puffed out to approximately the original form.

The pierced hole of the second gas injection is sealed by an adhesive label which ensures a hermetic seal during the storage period, but opens automatically under the effect of heat, steam and/or pressure when the product is re-heated by the consumer.

In the above-mentioned method the container can also be actively cooled externally during the first gas injection. This cooling process can be achieved, for example, by a water bath or a cooling tunnel. Such a cooling process results in an additional cooling of the food provided in the packaging, in particular if liquid has collected at the bottom of the packaging, and thus assists the cooling by the first gas injection. Such a cooling also leads to a cooling of the side walls of the packaging and thus to an increased condensation of the steam on the side walls.

### FIGURES

The invention will be explained hereinafter in greater detail with reference to an embodiment in conjunction with the drawings, in which:

FIG. 1 shows a container, which is suitable for use within the scope of the method according to the invention, with a venting opening and food before said food is preserved;

FIG. 2 shows the container of FIG. 1 during heating by means of microwaves;

FIG. 3 shows the container comprising a cannula piercing into the cover film of said container;

FIG. 4 shows the injection of a gas with the cannula into the container;

FIG. 5 shows the sealing of the venting opening and of the pierced hole formed by the cannula by means of an adhesive label;

FIG. 6 shows the sealed container with the food preserved in accordance with the invention; and

FIG. 7a shows a suitable cup packaging for use within the scope of the method according to the invention comprising with two injection steps;

FIG. 7b shows the cup packaging of FIG. 7a during a heating process by means of microwaves;

FIG. 7c shows the cup packaging during a first injection of a gas with a piercing cannula;

FIG. 7d shows the sealing of the venting opening and of the pierced hole, formed by the first cannula, by means of a permanent adhesive label;

FIG. 7e shows the contracted cup packaging during a cooling step;

FIG. 7f shows the cup packaging during a second injection of a gas with a piercing cannula;

FIG. 7g shows the cup packaging sealed by a second adhesive label with the food which has been preserved in accordance with the invention.

### DETAILED DESCRIPTION

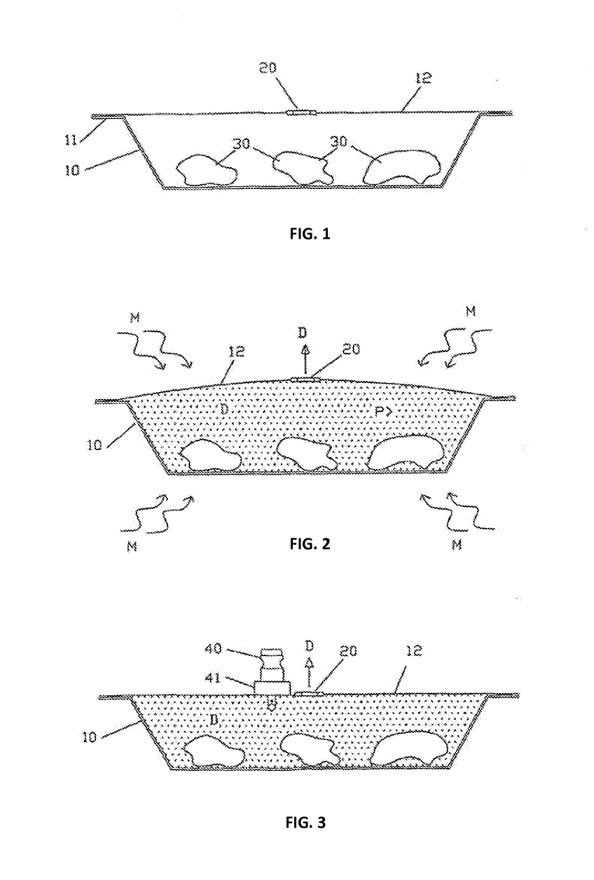

FIG. 1 shows a shell-like container 10 made of polypropylene comprising a peripheral edge 11 onto which a cover film 12, which is likewise peripheral, is welded. The weld connection is preferably peelable.

The cover film is a multi-layered plastic film less than 100 μm thick, wherein one layer consists of biaxially oriented polyethylene terephthalate (PET) and a second layer consists of polypropylene, and wherein the layer of polypropylene is 50 μm thick and the layer of PET is 23 μm thick. A high barrier which consists of silicon oxide, aluminum oxide or ethylene vinyl alcohol may be present between the two layers.

A venting opening 20 with a diameter of approximately 2.5 mm is provided in the cover film 12 and is formed by laser perforation and thus comprises a small fusion edge.

Food 30 is provided in air in the container 10 and has a specific inherent moisture and, for example, is still present in the raw/fresh state.

FIG. 2 shows the container 10 during heating with microwaves M to preserve the food 30, wherein steam D has formed from the moisture contained in the food 30 and has caused an overpressure P> in the container 10. Under the action of said overpressure P>, steam D together with the air which was originally present flows out from the container 10 through the venting opening 20. The cover film 12 has also expanded and bulged under the action of the overpressure P>.

The pressure in the container 10 rapidly decreases, above all by condensing steam D, after the heating process and with cooling, in such a way that the cover film 12 can also return, at least approximately, back to its original flat form. In this phase the cover film 12 is pierced in the vicinity of the venting opening 20 by means of a cannula 40, as shown in FIG. 3.

The cannula 40 is provided with a stop collar 41, which is slightly set back relative to the tip of said cannula, and is preferably inserted until said stop collar 41 rests against the outer face of the cover film 12. The stop collar 41, which may have a diameter of 10-20 mm, in particular of 14 mm, prevents excessively deep penetration of the cannula 40 into the container 10. Its tip only protrudes to such an extent beyond the stop collar 41, in particular only approximately 5-15 mm, preferably 7 mm, that it does not contact the food 30 where possible. The tip is ground to form three cutting edges which are offset from one another by 120° and are inclined by approximately 22° to the axial direction.

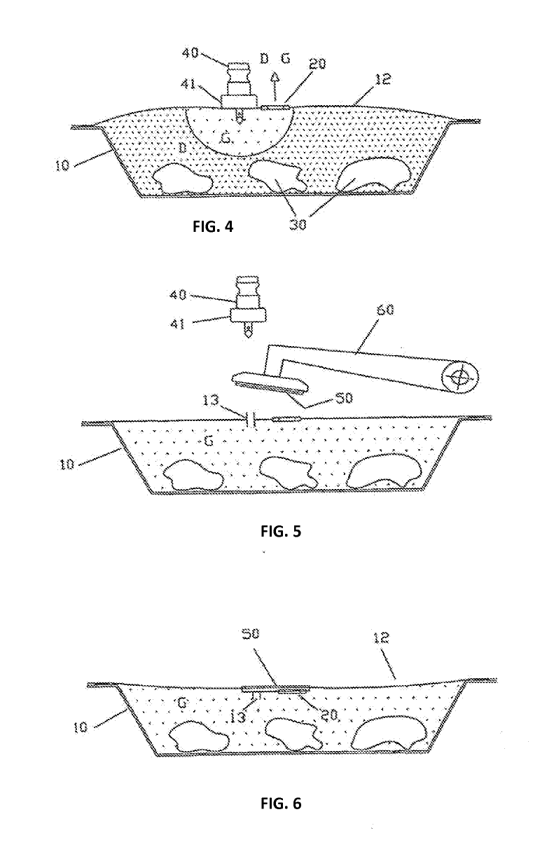

As is shown in FIG. 4, a gas G is then injected via the cannula 40 into the container 10 at an overpressure of approximately 0.3 bar. The necessary gas feed to the cannula 40 is not shown in FIG. 4, similarly to the other figures. The gas G emerges radially at a plurality of openings distributed over the periphery between the tip and the stop collar 41 of the cannula 40. The cover film 12 expands slightly again owing to the renewed overpressure and bulges upwardly. It presses against the stop collar 41 of the cannula 40, whereby the pierced hole denoted by 13 in FIG. 5 is additionally stabilized against tearing and a certain sealing effect is also experienced. In order to ensure that the cover film 12 is not pressed in too excessively by the cannula 40 and the stop collar 41 thereof, it is pulled back again slightly during the gas injection, for example by 1-3 cm, as is also shown in FIG. 4.

The container 10 is flushed with the gas G, thus expelling steam D and any air still present through the venting opening 20, and this occurs until no significant vacuum can form as a result of further steam condensation in the container after the aforementioned sealing of the container, or until the content of any oxygen contained in the container has decreased to approximately 0.1%. The injected gas must, of course, itself be free from oxygen where possible.

FIG. 5 shows the container 10 after the injection of the gas G, wherein the cannula 40 has already been withdrawn again fully from the container 10. The container 10 must now still be sealed.

In order to close the container 10 the pierced hole 13 and the venting opening 20 in the cover film 12 are sealed by applying an adhesive label 50. A plunger 60 which picks up the adhesive label 50, for example from a label dispenser (not shown) and holds it, for example by suction, until it is applied on the container 10 is used to apply the adhesive label 50.

A specific period of time between approximately 0.5 and 10 seconds elapses between the end of the gas injection and the withdrawal of the cannula 40 on the one hand, and the application of the adhesive label 50 on the other hand. During this period the overpressure generated in the container 10 by the injection of the gas G may decrease again, at least in part, owing to the venting opening and the pierced hole 13 formed in the cover film 12 by the cannula 40, wherein the film returns to its flat form. In addition, the oxygen content in the container may advantageously increase to 4-5% owing to a specific backflow or back-diffusion of external air. Lastly, the temperature may decrease again slightly, which is advantageous in order to support the adhesive label on the film.

FIG. 6 shows the container 10 with the food 30 preserved in accordance with the invention in the gas atmosphere G and with the adhered adhesive label 50 at ambient pressure. The cover film 12 is easily drawn in under the influence of a certain subsequent condensation of residual steam once the adhesive label has been applied, but this is not detrimental to the food contained in the container and helps to ensure that the cover film is stretched tight and also remains in place in the long term. In this form the container is suitable as a transport and retail packaging and is further preferably supplied to a conventional cooling chain with cooling temperatures in the range of 1-8° C.

For sufficient preservation of the food 30 it is important that a temperature of 90-98° C. is reached for 30-90 seconds in the core of the food during the heating process. As a criterion for this the container 10 can be weighed before the heating process and after the sealing process, and from this the weight loss caused by the escape of steam can be ascertained. If it is too low, it means that a sufficient temperature has not been reached or was only reached for an insufficient period of time. The relevant container 10 can then be rejected.

Before consumption of the food preserved by the described method, it is heated in the packaging, typically in a microwave oven, to consumption temperature. In order to enable heating in conventional ovens at relatively high temperatures, the shell-like container 10 and the polyethylene terephthalate layer of the cover film 12 can consist of crystalline polyethylene terephthalate (C-PET) with a melting point above 230° C. The second layer of the plastic film is a connection layer which consists of an adhesion promoter. The cover film can thus be adhered to the edge of the shell-like container after activation of the adhesion promoter.

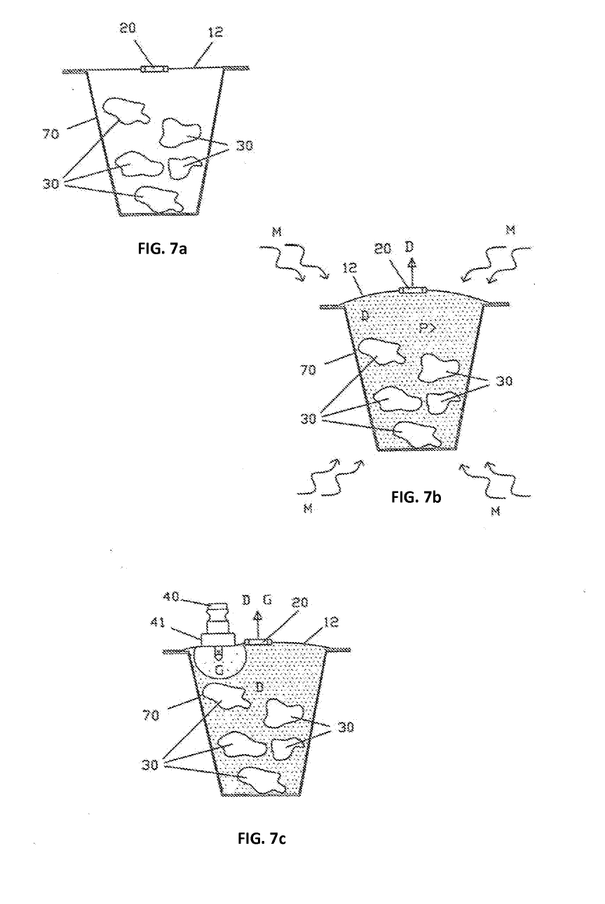

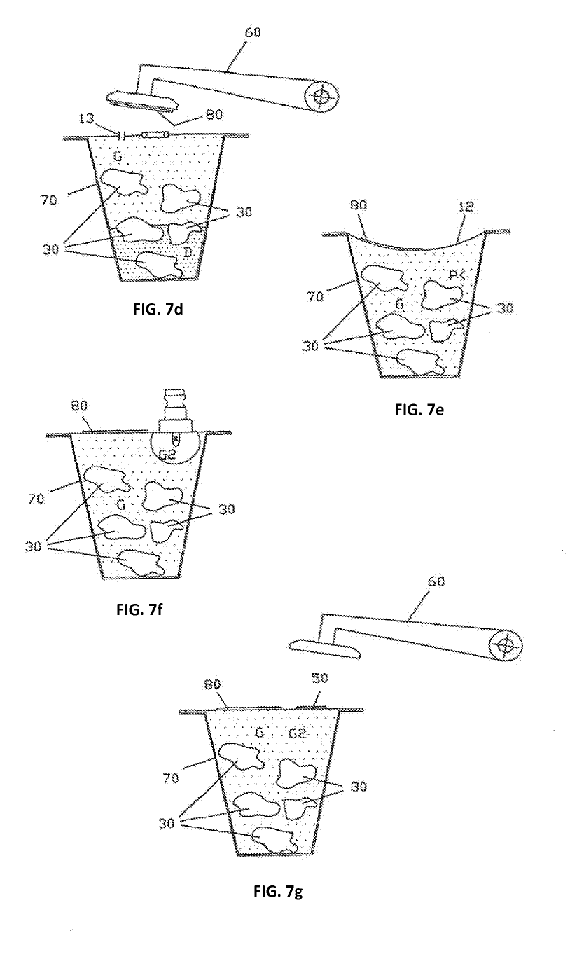

It may be that the gas flushing is insufficient with the use of cup-like packagings for example, and that the packaging contracts significantly after being sealed during cooling. In order to avoid this, a cooling step and a second gas injection are carried out after the gas flushing, as is shown in FIGS. 7a-g.

FIG. 7a shows a suitable cup packaging 70 for use within the scope of the method according to the invention with two injection steps. Food 30 in air is provided in the cup packaging 70. The cup packaging 70 with a height of 80 to 140 mm and a diameter of 60 to 200 mm also has a cover film 12 and a venting opening 20. It differs from the container 10 mentioned above merely in shape.

FIG. 7b shows the cup packaging 70 of FIG. 7a during a heating process by means-of microwaves M in order to preserve the food 30, as has already been described for the container 10 of FIG. 2. Steam D has formed from the moisture contained in the food 30 and the cover film 12 has expanded and bulged under the action of the overpressure P> produced. Some of the steam D, together with the air originally present in the cup packaging 70, escapes through the venting opening 20.

FIG. 7c shows the cup packaging 70 during a first injection of a gas G with a cannula 40 which has pierced through and comprises a stop collar 41. This process is also carried out in the manner as already described for the container 10 of FIG. 3 and FIG. 4. Owing to the geometry of the cup packaging it may be that the cup packaging 70 is not sufficiently flushed and steam D remains in the lower third of the cup packaging, as shown in FIG. 7d.

FIG. 7d also shows the sealing of the venting opening 20 and of the pierced hole 13, formed by the first injection, by a permanent adhesive label 80. In this case the permanent adhesive label 80 is still retained by the plunger 60. This permanent adhesive label 80 has an adhesive which no longer detaches, even when subjected to pressure and increased heat.

Once the permanent adhesive label 80 has been affixed, the cup packaging 70 is cooled in a cooling step from the pasteurization temperature to approximately 65° C. Depending on requirements, it can also be cooled further, for example to 2-4° C. As the cooling takes place the pressure in the cup packaging 70 decreases and the cup packaging 70 constricts under the vacuum P< produced. The cover film 12 is drawn inwards. FIG. 7e shows the cup packaging 70 which is drawn in during a cooling step.

FIG. 7f shows the cup packaging 70 during a second injection of a gas G with a cannula 40 which has pierced through and comprises a stop collar 41. The second injection is carried out at a point which is offset from the first injection site. During the second injection, gas G2 is injected until the constricted cup packaging 70 has been puffed out again to its original form. During the second injection it is suffice to apply a lower overpressure than that during the first injection. The overpressure during the second injection may be approximately 0.2 bar.

FIG. 7g shows the cup packaging 70, which is sealed by an adhesive label 50, with the food 30 preserved in accordance with the invention. The adhesive label 50 is applied to the cup packaging 70 in the manner already described above for the container 10.

Alternatively to the above-described design of the plastic film and irrespectively thereof, the design of the cannula described above could be considered as an independent inventive concept to improve the method known from WO 2006/084402 A1, in particular in terms of the stop collar and/or movement of said cannula. The same also applies at least to the waiting period between the end of the gas injection and the sealing of the container and/or to the method with an intermediate cooling step and a second gas injection.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

What is claimed is:

1. A method for preserving food in a container, wherein said container comprises a venting opening and a wall of a plastic film and is suited as transport and retail packaging;
wherein the plastic film has a thickness of less than 100 μm, and wherein at least one layer of the plastic film is made of polyethylene terephthalate;
the method comprising the steps of:
providing the container with the food inside;
heating the food in a moist state in the container by microwaves (M) for a limited time, however at least until hot steam (D) forms in the container and exits through the venting opening;
after the step of heating the food has ended, using a cannula for piercing the plastic film container wall to form a pierced hole and injecting a gas (G) into the container through the pierced hole; and
after the step of injecting the gas, closing the venting opening and the pierced hole.
